(19) United States
(12) Patent Application Publication
(10) Pub. No.: US 2012/0205885 A1
(43) Pub. Date: Aug. 16, 2012

(54) PORTABLE SKI TROLLEY

(76) Inventor: KEVIN MICHEAL DOMVILLE, PINZOLO (IT)

(21) Appl. No.: 13/208,244

(22) Filed: Aug. 11, 2011

(30) Foreign Application Priority Data
Feb. 12, 2011 (GB) 4018807
Jul. 22, 2011 (EP) 001895079-001
Jul. 22, 2011 (EP) 001895079-002

(51) Int. Cl. B62B 1/00

(52) U.S. Cl. 280/47.131

(57) ABSTRACT

The invention to which this application relates, is a method of attaching a pair of wheels to skis, thereby enabling the skis to be rolled over the ground. The invention is a webbing strap that receives a pair of wheels, which are then fastened around the end of the skis. The wheels are formed onto a right-angled bracket, the vertical facet inserts into the webbing strap, and the skis sit on the horizontal facet of the bracket. When the wheels are inserted into the strap, and the strap is fastened around the end of the skis, a form of trolley is produced, that allows the skis to be pushed or pulled along the ground. This invention is lightweight and compact and can be stored in a pocket whilst not in use.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

A problem for many skiers is transporting their skis from their accommodation or vehicle, to the ski slopes and back again. This generally requires people to carry heavy skis, whilst walking in cumbersome ski boots. Children in particular find this difficult, requiring adults to also carry their skis.

Problems associated with the practice of carrying skis include:
1 Exerting a physical strain on the person carrying the skis and exposing them to a risk of injury.
2 The skis are commonly carried on people's shoulders, which produces a long lever at around head height. This exposes other people to a risk of injury if the person carrying the skis should turn around.
3 Carrying the skis on the shoulder has the potential to damage the skier's jacket due to the sharp edges, ski wax and the ski bindings.

In the process of researching the invention to which this application relates, 2 other designs for devices to transport skis were identified. These 2 designs were published by the World Intellectual Property Organisation, with the following International Publication Numbers: WO 2004/087269 A1 and WO 2010/056140 A3.

Whilst the function of these existing devices for transporting skis is similar, there are several problems with their designs, which the invention to which this application relates attempts to address. These problems include the following:
1 The existing devices for transporting skis are too bulky, and cannot easily be inserted into a pocket when the skier arrives at the slopes.
2 The existing devices may need to be removed from the skis prior to further transportation of the skis on the roof of a vehicle. This could result in repeated refitting of the existing devices.
3 The existing devices would need to be removed prior to embarking in a cable car, as they would not fit into the external ski rack.
4 The existing devices are formed from plastic that may have the potential to damage skis.
5 The existing devices will potentially have greater production costs.

### BRIEF SUMMARY OF THE INVENTION

The invention to which this application relates, is intended to facilitate the transportation of skis, making it easier for skiers to transport their skis by hand, to and from the ski slopes. The invention allows the skier to attach wheels to their skis, allowing the skis to be pushed or pulled along the surface of the ground.

The invention is intended to address the problems associated with carrying skis, identified in the Background of the Invention, in the following ways:
1 To reduce the physical strain on the person transporting the skis, by reducing the need to lift skis onto the shoulder and be carried, thereby reducing their risk of injury.
2 To reduce the risk of injury to others, by allowing the skis to be rolled along the ground, and not carried at head height.
3 To reduce damage to ski clothing by refraining from carrying the skis on the shoulder.

The invention is intended to address the problems associated with existing devices for transporting skis, identified in the Background of the Invention, in the following ways:
1 To reduce the size and bulk of the device for transporting skis, so that the device can easily be placed into a pocket on arrival at the slopes, and not require further means of carrying the device when removed.
2 To allow the device for transporting skis to remain on the skis during transit on a car roof. This will reduce the frequency of removal and refitting of the device during a daily trip to and from the ski slopes in a car.
3 To allow the device to remain fitted on the skis during transit in a cable car, should further carrying of the skis be necessary at the top of the cable car.
4 To provide a flexible and non marking interface between the device and the skis during transit, thereby reducing possible damage to the skis.
4 To reduce the production costs of the device, thereby reducing the purchase price for customers, making the device more affordable.

### BRIEF DESCRIPTION OF THE SEVERAL VIEWS OF THE DRAWING

FIG. 1—Illustrates a front view of the strap with the wheels, prior to the wheels being inserted into the strap.

FIG. 2—Illustrates a front view of the strap with the wheels inserted

FIG. 3—Illustrates a rear view of the strap

FIG. 4—End view of the strap

FIG. 5—View of the strap with the wheels inserted and attached to the ends of skis

FIG. 6—Illustration of the skis being pushed and pulled with the wheels attached using the strap

### DETAILED DESCRIPTION OF THE INVENTION

The invention to which this application relates, is a method of attaching a pair of wheels to the tail end of skis, thereby enabling the skis to be rolled over the ground.

The invention is a webbing strap that receives a pair of wheels, which are then fastened around the end of the skis. When the wheels are inserted into the strap, and the strap is fastened around the end of the skis, a form of trolley is produced, that allows the skis to be pushed or pulled along the ground.

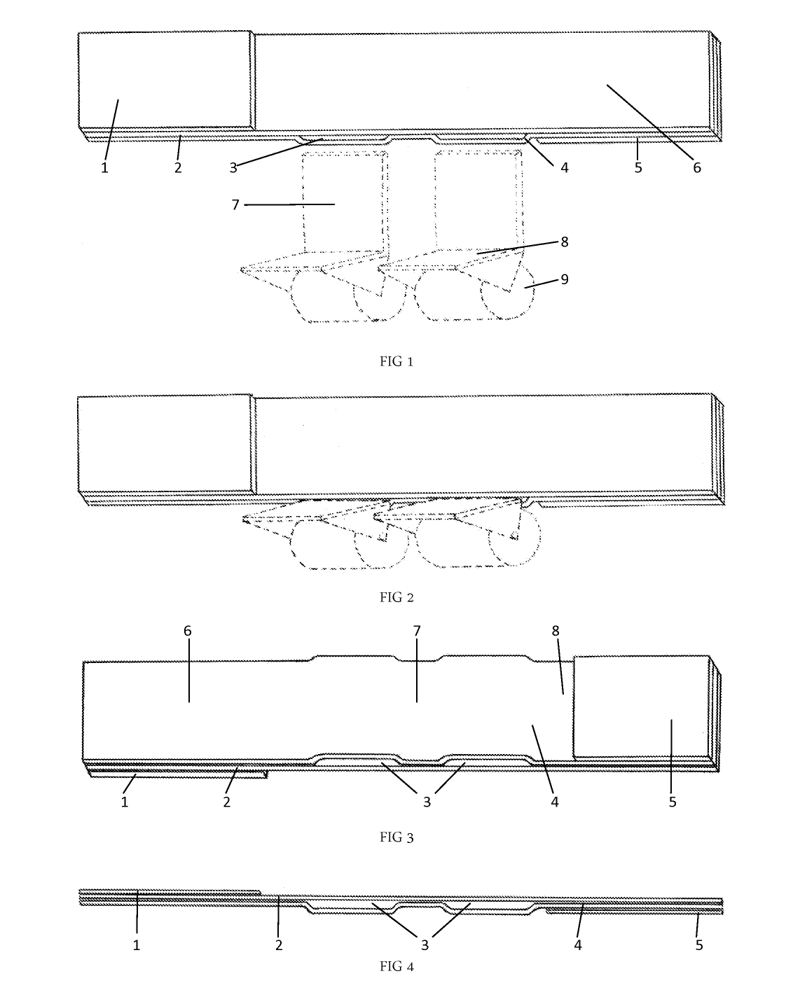

The assembly comprises of two lengths of nylon webbing band (FIGS. 1, 3 & 4; no's. 2 & 4), which are stitched or glued together to form three separated conjoined sections (FIG. 3; no's. 6, 7, 8). Between each section of the strap that is stitched or glued together, there is a section of the strap left unstitched/unglued. The two sections of the strap that are not stitched or glued together, form the two sleeves (FIGS. 1, 3 and 4; no. 3) that receive the wheels.

The wheels (FIG. 1; no 9) are formed on right angled brackets (FIG. 1; no's. 7,8). The vertical facets of the brackets (FIG. 1; no. 7) slide into the sleeves of the strap (FIG. 2).

Reciprocating lengths of hook and loop material (e.g. Velcro) are stitched or glued to the ends of opposite sides of the strap (FIGS. 1, 3 and 4; no's. 1, 5), to enable the two ends of the strap to be fastened together around the skis (FIG. 5; no. 3). The length of the strap may extend beyond one complete circumference of the tail end of the skis.

The internal surface of the strap (FIG. 1; no 2) that forms the interface with the skis (FIG. 1; no 6) will be covered in a non slip material, either by a coating or the addition of a layer of foam, to provide greater friction between the surface of the strap and the surface of the skis.

Once the wheels have been inserted into the strap (FIG. 2), the tail end of the skis (FIG. 5; no. 4) sit on the horizontal facets of the wheel brackets (FIG. 1; no 8/FIG. 5; no. 2). The strap then wraps around the skis (FIG. 5; no. 3), thereby attaching the wheels to the end of the skis (FIG. 5; no. 1). The wheels may or may not be permanently fixed into the sleeves of the strap.

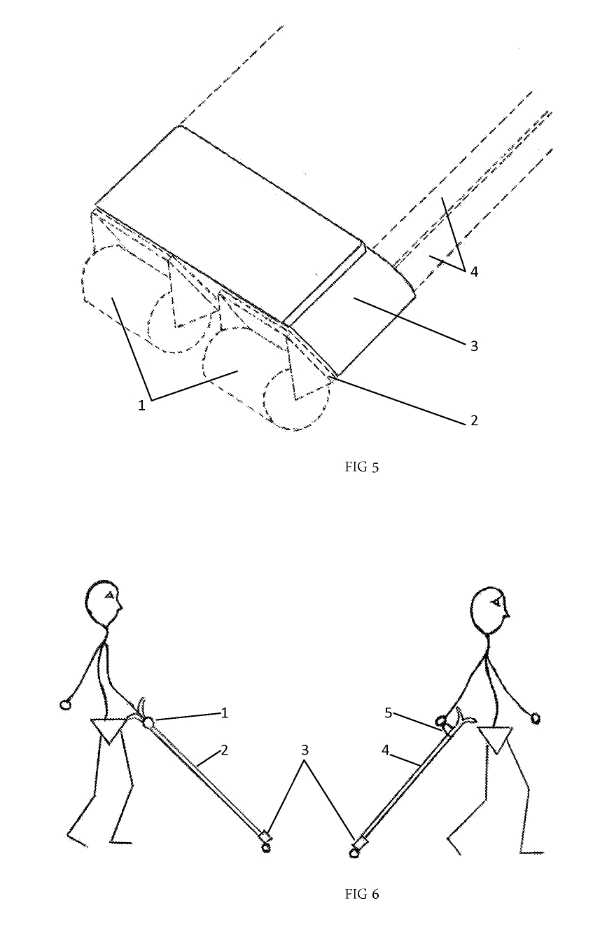

The result of this assembly is to allow the skis (FIG. 6; no's. 2 and 4) to be pushed or pulled along the surface of the ground (FIG. 6; no. 3). For pushing the skis, the person holds the skis directly (FIG. 6; no. 1). In order to pull the skis, a narrower webbing loop can be used, held in place with a normal ski strap, forming a leash type handle (FIG. 6; no. 5).

The invention to which this application relates has two significant advantages over existing devices for transporting skis. Firstly, the simplicity of the design; and secondly, the reduced bulk of the device.

The simplicity of the design of using the strap to attach wheels to skis, presents many advantages. It provides the opportunity for people of all ages, including children, to fit the wheels to the skis and transport them independently, thereby significantly reducing the physical strain of carrying skis. The low production costs would make the product more affordable, especially to families. The potential for malfunctions or damage to the ski transport device is also reduced, due to the simplicity of the components.

Existing designs offer a bulkier form of transportation for skis, which could present an encumbrance to the skier whilst on the slopes. This design enables the wheels to be easily stored in the pocket, once the skier has arrived at the slopes. Existing designs would require significant storage capacity for the ski transporting device, upon arrival at the ski slope. This is particularly relevant for a family group, where for example 4 devices may have been used.

The compact nature of the invention to which this application relates, also enables the strap and wheels to remain attached to the skis in situations where existing devices for transporting skis could not. For example, whilst transporting the skis on the roof of a vehicle the device would not need to be removed, so the skis could be transported with the wheels attached to and from the vehicle, without repeated fitting and removal of the device.

I claim:

1. A device for transporting skis by the use of a flexible strap, consisting of layers which are joined together in such a way as to accommodate wheels, thereby enabling the wheels to be attached to the end of skis for the purpose of rolling the skis along the ground.

2. A device for transporting skis according to claim 1, where the length, relative lengths or widths of the strap or fastening material will vary to accommodate differing types of skis.
